(19) United States
(12) Patent Application Publication
(10) Pub. No.: US 2009/0278022 A1
(43) Pub. Date: Nov. 12, 2009

(54) SCANNING DEVICE WITH U-SHAPED COVER

(76) Inventors: Stefan Dorn, Arnstein (DE); Marcus Mutschler, Remseck-Pattonville (DE)

Correspondence Address: Striker, Striker & Stenby, 103 East Neck Road, Huntington, NY, 11743, US

(21) Appl. No.: 12/390,704

(22) Filed: Feb. 23, 2009

(30) Foreign Application Priority Data
May 6, 2008 (DE) 10200822312.3

(51) Int. Cl. F16M 13/00

(52) U.S. Cl. 248/646

(57) ABSTRACT

A scanning device scans a dimensional standard which is situated on a guide rail which extends in a longitudinal direction, and has a body with a cross-section that is essentially U-shaped so that it may grip around the guide rail, at least one cover being provided on the outside of the scanning device and is designed as a profiled element, the cross section of which is U-shaped, having a base and two U-shaped legs, the cross-sectional shape of the cover being matched to the cross-sectional shape of the scanning device.

### CROSS-REFERENCE TO RELATED APPLICATION

The invention described and claimed hereinbelow is also described in German Patent Application DE 10 2008 022 312.3 filed on May 6, 2008. This German Patent Application, whose subject matter is incorporated here by reference, provides the basis for a claim of priority of invention under 35 U.S.C. 119(a)-(d).

### BACKGROUND OF THE INVENTION

The present invention relates to a scanning device and to a linear bearing including a scanning device of this type.

FIG. 4 shows a known linear bearing 10 which is composed of a guide rail 20 which extends in a longitudinal direction 21, on which a guide carriage 11 is supported in a longitudinally displaceable manner. Four tracks 23 for spherical rolling elements (not depicted) which circulate endlessly in guide carriage 11 are provided on guide rail 11 which is composed of hardened roller bearing steel. A deflection assembly 13 which transfers the endlessly circulating rolling elements from the carrying zone into a return channel (not depicted) in guide carriage 11, and vice versa, is provided on each of the two longitudinal front sides of guide carriage 11.

A scanning device 30 which encloses guide rail 20 and guide carriage 11 in a U-shaped manner is mounted on one of the deflection assemblies 13. A separate sensor 39 which is designed as described in DE 10 2007 009 994 is provided in the scanning assembly. Sensor 39 is used to scan a dimensional standard 22 which is situated between two tracks 23 on a lateral surface of guide rail 20. Dimensional standard 22 is designed in the shape of a strip of sheet metal in which a large number of periodically arranged, rectangular cut-out sections is provided which are scanned inductively by sensor 39 using a plurality of electrical coils in order to determine the position of guide carriage 11 relative to guide rail 20. The design of dimensional standard 22 is described in detail in EP 1 052 480 B1. The mode of operation of sensor 39 is described in EP 1 164 358 B1. The attachment of separate scanning device 30 to guide carriage 11 is designed as described in DE 103 47 360 A1.

Reference is made to adapter plate 14 which is fixedly connected to deflection assembly 13, and which is detachably connected to scanning device 30. A planar mating surface for scanning device 30 which is oriented exactly at a right angle to the direction of motion, i.e. longitudinal direction 21 of linear bearing 10, is provided on adapter plate 14, so that sensors 39 are therefore oriented exactly parallel to dimensional standard 22. An end seal 15 which prevents dirt from entering scanning device 30 and guide carriage 11 is provided on the front side of scanning assembly 30. Connecting cable 36 for connecting scanning device 30 to a higher-order control device is merely suggested in the illustration. A further sensor (not depicted) is provided on the side opposite sensor 39, with which reference marks or an absolute dimensional standard is scanned in order to determine an approximate position.

Two lateral covers 59 and one top cover 60 are provided to facilitate installation of sensors 39 and evaluation electronics 40 (depicted in a basic schematic manner), lateral covers 59 and top cover 60 each being attached using four fastening screws 41 to a main body 33 which has been milled out of a metallic solid body. To prevent fluids from penetrating evaluation electronics 40 and sensors 39 from the outside, inner space 43; 44 of scanning device 30 is filled with a casting compound in the form of a liquid polyurethane resin which hardens in scanning device 30 and encloses the components mentioned above in a fluid-tight manner.

The casting compound is applied as described below. With lateral cover 59 open, lateral spaces 43 are filled with as much casting compound as possible. To prevent the casting compound from escaping through the gap between sensor 30 and main body 33, it is sealed with latex (a “latex shell”). After this first casting step, lateral covers 59 are installed, and the gap between lateral covers 59 and main body 33 are also sealed using latex. Next, with top cover 60 removed, casting compound is filled into top space 44 of main body 33, and the casting compound may then flow via connecting channels (not depicted) into lateral spaces 43 and fill them completely. Upper space 44 is not filled completely, but rather only to the extent that evaluation electronics 40 and all cables connected therewith are completely covered by the casting compound. Finally, top cover 60 is installed, and the latex shells which were applied previously are removed. Main body 33 is tilted in various positions relative to the direction of gravity during the process of applying the casting compound described above, in order to ensure that the casting compound reliably fills all opens spaces in main body 33.

### SUMMARY OF THE INVENTION

The object of the present invention is to simplify the installation of the cover. At the same time, the installation space provided for the sensor and the evaluation electronics will be increased. In addition, the casting of the scanning device will be simplified.

It is provided that the cover is designed as a profiled element, the cross section of which is U-shaped, having a base and two U-shaped legs, the cross-sectional shape of the cover being matched to the cross-sectional shape of the scanning device.

Given that only one cover is provided, the number of fastening means may be minimized, thereby simplifying assembly. In addition, the assigned counter-fastening means in the main body of the scanning device may be eliminated, thereby creating additional installation space. Another result of the fact that the counter-fastening means are eliminated is that the receiving space for the sensors and the evaluation electronics is much less angular. Accordingly, it is considerably easier to apply the casting compound in a manner such that the entire interior of the scanning device is completely filled with casting compound.

The cover may be extruded, preferably being extruded out of aluminum. The cover may be manufactured particularly cost-effectively in this manner.

Even though it is feasible to manufacture the cover out of plastic via extrusion, it is preferable to use an electrically conductive aluminum cover. This allows the evaluation electronics to be protected particularly well against electromagnetic interferences which act on the scanning devices from the outside. At the same time, aluminum is highly resistant to the fluids used in the vicinity of the scanning device, e.g., coolants in machine tools.

The length of the U-shaped legs may be essentially equal to the height of the scanning device. It is therefore possible to provide the largest possible opening for the interior space of the evaluation device, thereby simplifying the installation of the sensors and the evaluation electronics. It is preferable to terminate the U-shaped legs of the cover in a flush manner with the underside of the scanning device without the front surface of the U-shaped legs abutting the main body of the scanning device. The length of the U-shaped legs may therefore be manufactured in a relatively inaccurate manner via extrusion without impairing the accurate fit of the cover on the main body.

The longitudinal front surfaces of the cover may be planar in design and preferably oriented perpendicularly to the longitudinal direction, in which case they bear against a planar counter-surface on the adjacent component, preferably the main body, of the scanning device. The longitudinal front surfaces of the cover are still machined in a material-removing manner when the extruded raw profile is trimmed. They may therefore be manufactured in a highly accurate manner. The length of the cover, in particular, may be manufactured in a highly accurate manner. Accordingly, the sealing gap between the longitudinal front surface of the cover and the planar counter-surface of the adjacent component may be particularly narrow in design, which is why the scanning device is very well protected against fluids which penetrate from the outside. The longitudinal front surfaces and the counter-surface are planar in design, thereby enabling them to be manufactured particularly easily. The orientation of the longitudinal front surface transversely to the longitudinal direction is preferred, because the cover may then be easily installed on the scanning device using a straight-line installation motion transversely to the longitudinal direction.

The scanning device may be filled with a casting compound, the cover being secured on the scanning device in a form-fit manner via the casting compound. The cover is therefore fixedly connected to the rest of the scanning device via casting, which must be carried out anyway. The large number of screws known from the prior art may be eliminated. With the cover installed on the scanning device, the liquid casting compound is filled into the scanning device and hardens therein. The minimally angled receiving space for the sensor and the evaluation electronics, which is made possible via the U-shaped cover, is particularly significant in this embodiment, since it ensures that the interior of the scanning device will be completely filled with casting compound. A visual inspection of the casting for unfilled spaces, which may not be performed with the cover in place, may be eliminated.

The form-fit connection between the cover and the casting compound may be brought about by the fact that the cover includes—as viewed in the cross section—at least one inwardly oriented projection which engages in the casting compound. The inwardly oriented projection may be manufactured directly via extrusion and, therefore, without additional costs. The projection preferably extends across the entire length of the cover, thereby resulting in a particularly inwardly-oriented and fixed connection to the hardened casting compound.

To prevent the U-shaped legs from bending during operation of the evaluation device, the shape of the projection may be selected such that the casting compound reaches behind the projection. The rearward attachment also makes it difficult for the cover to be removed from the scanning device. To form the rearward attachment, a preferred approach is to design the inwardly oriented projection as a segment which is slanted relative to the U-shaped leg, or as a hook-type, T-shaped, or Y-shaped—as viewed in the cross section—segment.

At least one inlet opening may be provided in the scanning device, via which the casting compound may be applied when the cover has been placed on the scanning device, the inlet opening being closed via an electrically conductive closing means which engages in the cover and in an adjacent component of the scanning device. Via the electrically conductive engagement of the closing means with the cover and the adjacent component of the scanning device, preferably the main body, an electrically conductive connection between these components is established in a reliable manner. The aim is to connect the cover to ground potential in particular, thereby ensuring that the cover is shielded in an optimum manner from electromagnetic interferences that act from the outside. At the same time, the inlet opening is closed tightly by the closing means. In addition, the cover is secured against displacement relative to the adjacent component. In this manner, it is possible to prevent the two components which are engaged with the closing means from becoming accidentally displaced while the casting compound is hardening.

It should be pointed out that electrical contact between the cover and the main body may also occur since the two components are in direct contact with one another. This electrical contact is eliminated in some cases, however, by the casting compound which penetrates the particular joining gap. This problem may be reliably prevented using the closing means which are installed after casting.

The closing means are preferably a self-tapping screw bolt, thereby making it possible to eliminate threads—which are costly to produce—in the cover and in the adjacent component. In addition, via the self-tapping thread, the electrical contact between the screw bolt and the associated counter-piece is improved. A “self-tapping screw bolt” refers to a screw bolt which forms the associated internal thread during the screw-in process using material-removing cutting processes or material deformation.

It is possible to provide at least one undercut recess on the inside of the cover, the undercut recess being connected in a fillable manner to the inlet opening, and the closing means being enclosed, in sections, by the undercut recess. Using the undercut recess, it is possible to create—in a cost-effective manner—a connection in the profiled cover between the internal thread which is assigned to the closing means and the inner space of the evaluation device, which is enclosed by the cover, so that the casting compound may flow from the inlet opening into the interior space of the evaluation device. It should be pointed out that this embodiment—in conjunction with the self-tapping screw bolt—has the disadvantage that the chips which are produced during the shaping of the internal thread may reach the evaluation electronics, thereby possibly resulting in a short circuit. The undercut recesses are therefore provided with an internal thread using a separate working step, so that the chips which are produced may be reliably removed from the cover before it is installed on the scanning device.

The undercut recess may be situated in a corner region between the base and a U-shaped leg of the cover. Using this configuration it is possible to apply the casting compound easily and reliably in the upper space in the region of the base, and in the lateral space in the region of the U-shaped legs. Preferably, an undercut recess is provided in both corner regions between the base and the two U-shaped legs, so that both lateral spaces may be reliably filled with casting compound in the region of the two U-shaped legs of the cover.

At least one arresting means which may engage in counter-arresting means on an adjacent component of the scanning device may be provided on the cover. The arresting means are used to prevent the cover and the adjacent component from becoming displaced before the casting compound is applied and the closing means are installed. The cover is therefore secured against displacement relative to the adjacent component while the latex shield is installed and the casting compound is applied.

The arresting means may be formed by an arresting projection which is located on the end—that faces away from the base—of at least one U-shaped leg, and preferably on both U-shaped legs, at least one detent recess which is matched to the arresting projection being provided in the adjacent component. The arresting projection may be manufactured particularly easily and without generating additional costs by extruding the cover. In addition, the arresting projection does not weaken the relatively thin-walled cover. An arresting projection on the end of the U-shaped leg also has the advantage that the elasticity of the U-shaped legs is utilized particularly well for the arresting effect. A relatively large arresting projection may therefore be provided without this resulting in an excessive increase in the installation force of the cover.

A U-shaped main body of the scanning device may be manufactured via metal-injection molding. In metal-injection molding, which is known per se, a mixture of fine metal particles and plastic is brought into the desired shape using the known, cost-effective plastic forming procedures, e.g. injection molding. The “green product” is then subject to thermal treatment, in which the plastic is broken down and the metal particles are welded to one another. The shrinkage that occurs in this process must be taken into account when the green product is sized. Using the method which is provided, it is possible to manufacture the main body—which is formed in a complicated manner—of the scanning device in a cost-effective manner and with the required accuracy.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a perspective view of an evaluation device according to the present invention;

FIG. 2 shows a first embodiment of the cover, in a cross-sectional view;

FIG. 3 shows a second embodiment of the cover, in a cross-sectional view; and

FIG. 4 shows a known linear bearing which includes a known scanning device.

### DESCRIPTION OF THE PREFERRED EMBODIMENTS

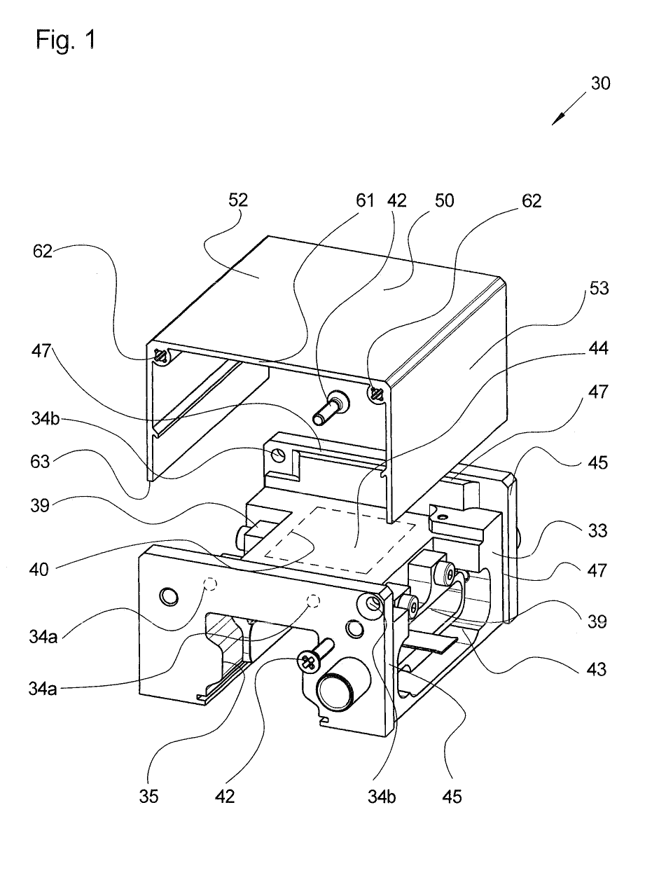

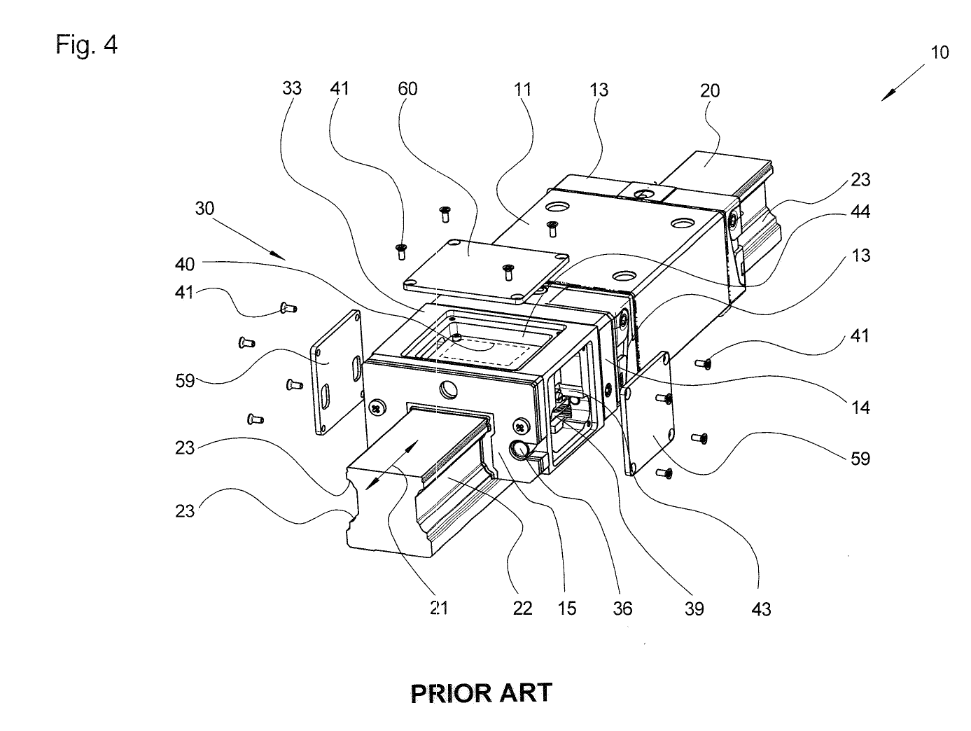

A scanning device according to the present invention is labelled in general with reference numeral 30 in FIG. 1. Scanning device 30 is provided for use with the linear bearing which was described with reference to FIG. 4. It is intended to replace the scanning device provided therein.

Scanning device 30 includes a main body 33 which is manufactured using the metal-injection method, and which has a U-shaped design overall, inner contour 35 of main body 33 being designed essentially equidistantly to the assigned guide rail of the linear bearing. A sensor 39 for scanning an assigned dimensional standard is situated on each of the U-shaped legs of main body 33. The two sensors are essentially designed as described in DE 10 2007 009 994. A front plate 45 is situated on each end of main body 33, being formed as a single piece therewith. Contact surfaces 47 of front plates 45, which are designed to bear against longitudinal front surfaces 61 of cover 50, are planar in design, thereby enabling cover 50 to be sawed off of an extruded aluminum profile using one straight cut. Cover 50 is slid onto main body 33 so far that base 52 touches stop 47 on main body 33.

Front surface 63 of U-shaped leg 53 does not bear against main body 33, so cover 50 bears against main body 33 in the vertical direction which is determined statically. The length of lateral U-shaped legs 53 of the cover is matched to main body 33 in a manner such that lateral space 43 is completely covered. Evaluation electronics 40 (depicted in a basic schematic manner) are located in upper space 44 in the region of the base of main body 33. Upper space 44 and two lateral spaces 43 are designed such that the casting compound may flow back and forth, essentially unhindered, between the two spaces during filling, thereby ensuring that the two spaces 43; 44 may be completely filled with casting compound.

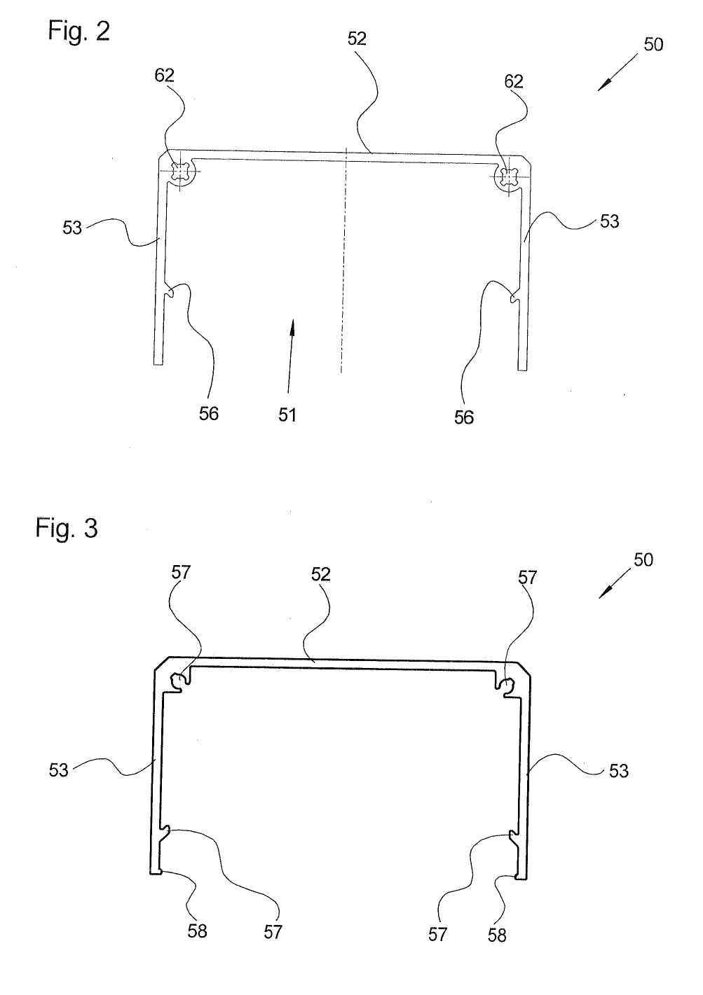

A through-bore 34b for an electrically conductive screw bolt 42 made of steel is provided in both front plates 45, thereby enabling screw bolt 42 to engage in assigned longitudinal passage 62 in cover 50 in order to establish an electrically conductive connection between cover 50 and main body 33, and to fixedly connect the parts mentioned above to one another. FIG. 1 shows a cover 50 according to a first embodiment which is depicted in greater detail in FIG. 2. In this embodiment, two separate filling openings 34a for the casting compound are provided; they are depicted in FIG. 1 in a basic schematic manner. Separate filling openings 34a are closed using separate closing means (not depicted) in the form of screw bolts.

Main body 33 shown in FIG. 1 may also be used in conjunction with a second embodiment of cover 50, which is shown in greater detail in FIG. 3. In this embodiment, instead of longitudinal passage 62, undercut recesses 47 are provided for engagement with screw bolts 42. The casting compound may therefore be applied via inlet openings in the form of through-bore 34b in scanning device 10, the inlet openings being provided anyway for screw bolts 42. In this case, screw bolts 42 are used simultaneously as closing means for inlet opening 34b. Independently of the embodiment of the cover, the casting compound may be applied to the scanning device, in the form of a polyurethane resin, e.g. using a plunger syringe to which a thin cannula has been attached, via inlet opening 34a or 34b. The scanning device which has been filled with liquid casting compound is swiveled and tilted slightly to ensure that all cavities to be filled are completely filled with casting compound. After the casting compound has been applied, inlet openings 34a or 34b are closed to allow the casting compound to harden.

FIG. 2 shows a first embodiment of cover 50, in a cross-sectional view. Cover 50 is manufactured as a single piece out of aluminum via extrusion. The cross-sectional profile shown is constant across the entire length of cover 50. Cover 50 includes a base 52 and two U-shaped legs 53 which project therefrom at right angles, each of which having an essentially constant wall thickness. A longitudinal passage 62 is provided on each inner side 51 of cover 50 in the region of the corners between base 52 and the two U-shaped legs 53, longitudinal passage 62 being open only toward both longitudinal front surfaces of cover 50. Longitudinal passage 62 is used to screw in screw bolts (number 42 in FIG. 1) which establish the electrical contact between the cover and the main body. In this case, the screw bolts are designed to be self-tapping. Since longitudinal passage 62 is not open toward the lateral space and upper space (numbers 43 and 44 in FIG. 1), the chips which are produced when the screw bolts are turned are prevented from reaching the evaluation electronics, where they could cause a short circuit.

A projection 56 which engages in hardened casting compound in a form-fit manner is provided on each of the two U-shaped legs. Since projection 56 is designed to slant relative to U-shaped legs 53, the undercut that results prevents U-shaped legs 53 from bending in the lateral direction. This could cause gaps to form between the hardened casting compound and cover 50, into which fluid, e.g. coolant in machine tools, could enter, which is undesired.

FIG. 3 shows a second embodiment of cover 50, in a cross-sectional view. Since this cover is designed essentially identical to the first embodiment, only the differences from the first embodiment will be described below.

An undercut recess 57 for engagement with the screw bolts (number 42 in FIG. 1) which establish the electrical contact between cover 50 and the main body is provided in the corners between base 52 and the two U-shaped legs 53. Undercut recess 57 is essentially circular in design, as viewed in the cross section. Since undercut recess 57 is open toward the upper space and the lateral space (numbers 43 and 44 in FIG. 1), they may be used for application of the casting compound. In this embodiment of cover 50, the thread in undercut recess for engagement with the screw bolts mentioned above is preferably created in advance, so that the chips which are produced may be reliably removed from cover 50 before it is installed on the scanning device.

An arresting projection 58 is provided on each end—which faces away from base 52—of U-shaped leg 53, which may snap into a matching arresting recess in the main body of the scanning device. It is thereby ensured that cover 50 remains securely in the desired position relative to the main body while the casting compound is being applied.

Projection 57 is slanted in the opposite direction compared with the first embodiment. Via this orientation of projection 57, cover 50 is better prevented, by the casting compound, from being removed in the upward direction. In contrast, the cover according to the first embodiment may be slid onto the main body more easily.

It will be understood that each of the elements described above, or two or more together, may also find a useful application in other types of constructions differing from the types described above.

While the invention has been illustrated and described as embodied in a scanning device with unshaped cover, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A scanning device for scanning a dimensional standard, comprising a guide rail which extends in a longitudinal direction for situating the dimensional standard, a body having a cross-section that is substantially U-shaped so that it grips around the guide rail, at least one cover provided on an outside of the body, wherein the cover is configured as a profiled element, a cross section of which is U-shaped, and has a base and two U-shaped legs, with a cross-sectional shape of the cover being matched to a cross-sectional shape of the body.

2. The scanning device as defined in claim 1, wherein the cover is configured as an extruded cover.

3. The scanning device as defined in claim 2, wherein the cover is composed of aluminum.

4. The scanning device as defined in claim 1, wherein a length of the U-shaped legs is substantially equal to a height of the body.

5. The scanning device as defined in claim 1, wherein the cover has longitudinal front surfaces which are planar and bear against a flat counter-surface on an adjacent component.

6. The scanning device as defined in claim 1, wherein the body is filled with a casting compound, while the cover is secured to the body in a form-fit manner via the casting compound.

7. The scanning device as defined in claim 5, wherein the longitudinal front surfaces of the cover are situated perpendicular to the longitudinal direction.

8. The scanning device as defined in claim 5, wherein the flat-counter surface is provided on the body.

9. The scanning device as defined in claim 6, wherein the cover includes, as viewed in a cross section, at least one inwardly oriented projection which engages in the casting compound.

10. The scanning device as defined in claim 9, wherein the projection has a shape selected such that the casting compound reaches behind the projection.

11. The scanning device as defined in claim 6, wherein the body has at least one inlet opening, via which the casting compound is applicable when the cover has been placed on the body, wherein the inlet opening is closed via an electrically conductive closing means, which engages in the cover and in an adjacent compound.

12. The scanning device as defined in claim 11, wherein the closing means is configured as a self-tapping screw bolt.

13. The scanning device as defined in claim 11, wherein at least one undercut recess is provided on an inside of the cover and connected in a fillable manner to the inlet opening, and the closing means are enclosed, in sections, by the undercut recess.

14. The scanning device as defined in claim 13, wherein the undercut recess is located in a corner region between the base and a U-shaped leg of the cover.

15. The scanning device as defined in claim 1, further comprising at least one arresting means engageable in counter-arresting means on an adjacent component and provided on the cover.

16. The scanning device as defined in claim 15, wherein the arresting means are formed by an arrested projection which is located on an end that faces away from the base, of at least one U-shaped leg, and at least one detent recess which is matched to the arresting projection provided in the adjacent component.

17. The scanning device as defined in claim 16, wherein the arresting projection is located on an end of both U-shaped legs.

18. The scanning device as defined in claim 1, wherein the U-shaped body is configured as a metal-injection molding produced body.

19. A linear bearing, comprising a guide rail which extends in a longitudinal direction, on which a dimensional standard is provided, a guide carriage supported on the guide rail in a longitudinally displaceable manner, a scanning device as defined in claim 1, and which is configured separate from the guide carriage and mounted on a longitudinal front side of the guide carriage in order to scan the dimensional standard.
